(19) United States
(12) Patent Application Publication
(10) Pub. No.: US 2010/0249970 A1
(43) Pub. Date: Sep. 30, 2010

(54) PLANNING APPARATUS, PLANNING METHOD AND PLANNING PROGRAM

(75) Inventor: Taku KOIKE, Takamatsu (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/748,906

(22) Filed: Mar. 29, 2010

(30) Foreign Application Priority Data
Mar. 30, 2009 (JP) 2009-082526

(51) Int. Cl. G06F 19/00

(52) U.S. Cl. 700/100

(57) ABSTRACT

A planning apparatus includes: an assignment pattern which indicates a combination of objects assignable to an operation of a product process, and indicates an assignment quantity of which each object is produced in the operation; and an assignment plan which indicates a combination of the assignment pattern, and which indicates an assignment period in which production of the object indicated in the pattern is performed. The apparatus calculates a production quantity indicating a quantity of the object produced according to the assignment pattern, obtains an allowance quantity by subtracting a requested quantity from the production quantity corresponding to a period in which the object of the requested quantity is requested to be assigned for use, determines a period in which the allowance quantity is lower than a preset lower limit, and selects the assignment pattern that is applied to the determined period in order to increase the allowance quantity.

### CROSS-REFERENCE TO RELATED APPLICATIONS

This application is related to and claims priority to Japanese Patent Application No. 2009-82526 filed on Mar. 30, 2009 and herein incorporated by reference.

### BACKGROUND

1. Field

The present application relates to a planning apparatus that creates plans, such as an assignment plan to assign assignment objects, a planning method using the planning apparatus, and a planning program for implementing the planning apparatus.

2. Description of the Related Art

Production management operations in the manufacturing industry involve process planning work that determines the production quantity and the production order of products, such as end products and parts.

For example, production may be made more efficient by creating a production plan that allows the same product to be produced in a large quantity, collectively and continuously while considering the production time.

At the time of such creation of a process plan, conventionally, a skilled person in charge of planning who is doing the actual work has prepared a process plan. Recently, however, various methods of automatic planning have been proposed and have become practical.

These planning methods have been making it possible to automatically create effective production plans.

For example, Japanese Unexamined Patent Application Publication No. 06-143106 discloses a production plan correction system that creates a production plan with consideration given to factors, such as prevention of an out-of-stock condition of parts, at the time of correcting a production schedule.

### SUMMARY

It is an aspect of the embodiments discussed herein to provide a planning apparatus including: a requested quantity recording unit that records requested quantities of a plurality of types of assignment objects which are requested to be assigned and due dates of assignments; a pattern recording unit that records a plurality of pieces of assignment pattern information indicating an assignment pattern that combines at least one type of assignment object assignable in parallel and an assignment quantity of every type of assignment object; a plan recording unit that records an assignment plan combining the assignment pattern and an assignment time period related to the assignment pattern; a calculating unit that calculates an allowance quantity of each assignment object for every time period by subtracting an accumulated value of requested quantities from an accumulated value of assignment quantities, based on the requested quantity of an assignment object requested to be assigned and the due date of an assignment, the requested quantity and the due date of an assignment being recorded by the requested quantity recording unit, and the assignment plan recorded by the plan recording unit; a determining unit that determines whether there is a time period in which the allowance quantity calculated by the calculating unit is lower than a preset lower limit; an assignment pattern determining unit that selects at least one piece of assignment pattern information among the plurality of pieces of assignment pattern information recorded by the pattern recording unit if the determining unit has determined that there is a time period in which the allowance quantity is lower than the preset lower limit, and that determines an assignment time period related to the assignment pattern indicated by the selected at least one piece of assignment pattern information; and a plan adding unit that adds the assignment pattern and the assignment time period determined by the assignment pattern determining unit to the assignment plan recorded by the plan recording unit.

### BRIEF DESCRIPTION OF THE DRAWING

FIGS. 1A and 1B are explanatory views illustrating examples of a product to which a planning method of a first embodiment according to the present application may be applied;

FIGS. 2A and 2B are explanatory views illustrating examples of a product to which the planning method of the first embodiment according to the present application may be applied;

FIG. 3 is a block diagram illustrating a hardware configuration example of a planning apparatus according to the first embodiment of the present application;

FIG. 4 is a functional block diagram illustrating a functional configuration example of the planning apparatus according to the first embodiment of the present application;

FIG. 5 is a flowchart illustrating an example of a planning process of the planning apparatus according to the first embodiment of the present application;

FIG. 6 is an explanatory view illustrating an example of production patterns of the planning method according to the first embodiment of the present application;

FIGS. 7A to 7D are explanatory views illustrating specific examples of the planning method according to the first embodiment of the present application;

FIGS. 8A to 8D are explanatory views illustrating specific examples of the planning method according to the first embodiment of the present application;

FIGS. 9A to 9C are explanatory views illustrating specific examples of the planning method according to the first embodiment of the present application;

FIG. 10 is a flowchart illustrating an example of a pattern determination process of the planning apparatus according to the first embodiment of the present application;

FIG. 11 is an explanatory view illustrating an example of production patterns of the planning method according to the first embodiment of the present application;

FIG. 12 is an explanatory view illustrating a specific example of the planning method according to the first embodiment of the present application;

FIG. 13 is a functional block diagram illustrating a functional configuration example of a planning apparatus according to a second embodiment of the present application; and

FIG. 14 is a flowchart illustrating an example of a planning process of the planning apparatus according to the second embodiment of the present application.

### DESCRIPTION OF THE EMBODIMENTS

Producing the same product in large quantity, collectively, and continuously improves efficiency in production.

Accordingly, in an efficient production plan, it is planned that the same product is produced in quantities as large as possible by one production process, and that the production process is continuously carried out as many times as possible.

In cases where a plurality of pieces of production equipment is installed, a production plan of one or a plurality of types of products that may be concurrently produced is adjusted so that the number of pieces of production equipment concurrently operated is as many as possible. This may improve efficiency in production.

As a specific example of such a type of production, production including processes, such as press molding and casting that form a plurality of different parts using a pair of dies, may be exemplified.

Production including a process that cuts one large member, such as a steel plate or cloth, into a plurality of different parts may also be exemplified.

However, this embodiment is not limited to these types of production.

In conventional systems, no consideration is given to efficiently producing one or a plurality of types of products that may be concurrently produced.

The present embodiment uses a plurality of assignment patterns that are used for creating plans, such as production plans, and each of which combine the type of one or a plurality of types of assignment objects assignable in parallel and an assignment quantity of the assignment objects for every type. This enables various assignments under various circumstances to be made more efficient.

A planning apparatus, a planning method, and a planning program as described in the present embodiment cause an information processing device to operate as a a requested quantity recording unit which records requested quantities of a plurality of types of assignment objects which are requested to be assigned and due dates of assignments, a pattern recording unit which records a plurality of pieces of assignment pattern information representing an assignment pattern that combines the type of one or a plurality of types of assignment objects assignable in parallel and an assignment quantity of the assignment objects for every type, and a plan recording unit which records an assignment plan combining assignment patterns and assignment periods of time according to the assignment patterns.

Such an information processing device calculates an allowance quantity of each assignment object for every period of time by subtracting an accumulated value of requested quantities from an accumulated value of assignment quantities, based on the requested quantity of an assignment object requested to be assigned and the due date of an assignment, the requested quantity and the due date being recorded in the requested quantity recording unit, and the assignment plan being recorded in the plan recording unit.

The information processing device determines whether there is a period of time in which the calculated allowance quantity is lower than a lower limit previously set.

If the result of the determination is that there is a period of time in which the allowance quantity is lower than the lower limit, the information processing device selects one or a plurality of pieces of assignment pattern information among the plurality of pieces of assignment pattern information recorded in the pattern recording unit, and determines an assignment period of time according to an assignment pattern represented by the selected assignment pattern information.

The information processing device adds the determined assignment pattern and the assignment period of time to the assignment plan recorded in the plan recording unit.

Thus, it becomes possible to create a plan of efficiently producing one or a plurality of types of products that may be produced in parallel.

The configuration described in the present embodiment is not limited to production plans, and may be applied to creating various assignment plans, so that efficient assignment plans are created.

In the present embodiment, assignment pattern information representing an assignment pattern that combines a type of one or a plurality of assignment objects assignable in parallel and an assignment quantity of the assignment object for every type is created, and the assignment pattern information is previously recorded in the pattern recording unit.

An allowance quantity of each assignment object is calculated for every period of time by subtracting an accumulated value of requested quantities from an accumulated value of assignment quantities, based on the requested quantity of an assignment object requested to be assigned and the due date of an assignment, and the assignment plan recorded in the plan recording unit.

It is determined whether there is a period of time in which the calculated allowance quantity is lower than a lower limit previously set.

If it is determined that there is a period of time in which the allowance quantity is lower than the lower limit, assignment pattern information is selected among a plurality of pieces of assignment pattern information, and a time of carrying out assignment according to an assignment pattern represented by the selected assignment pattern information is determined.

This configuration produces excellent effects, such as creating a plan of efficiently assigning one or a plurality of types of products that are assignable in parallel.

Note that this configuration is not limited to production plans, and enables various assignments under various circumstances to be made more efficiently.

### FIRST EMBODIMENT

A planning method according to the present application may be applied to various types of fields such as creating production plans of products and assignments of various assignment objects.

In a first embodiment, description is given of creating production plans of products, particularly of creating a production plan of products that are parts required for manufacturing a finished product.

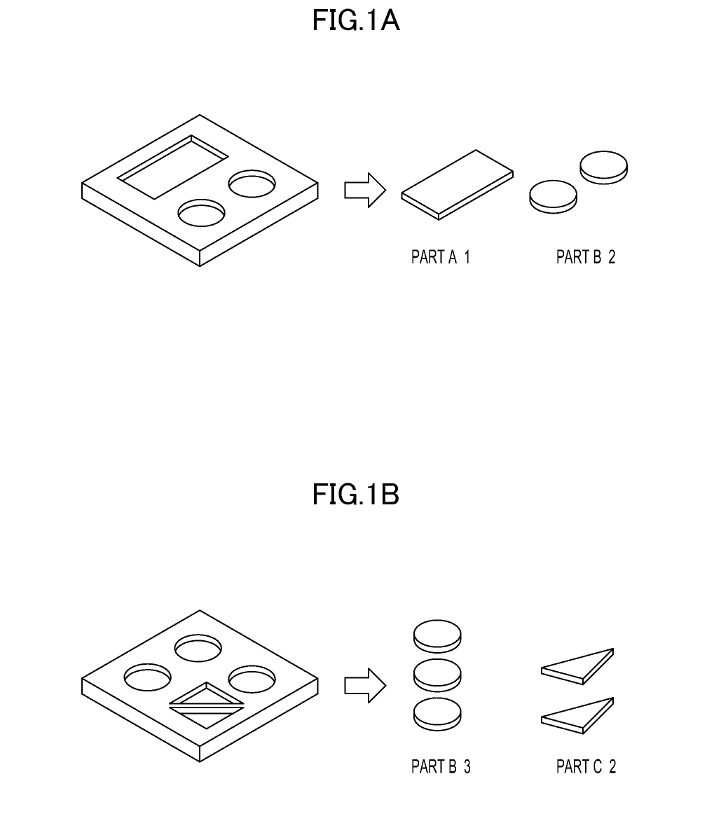

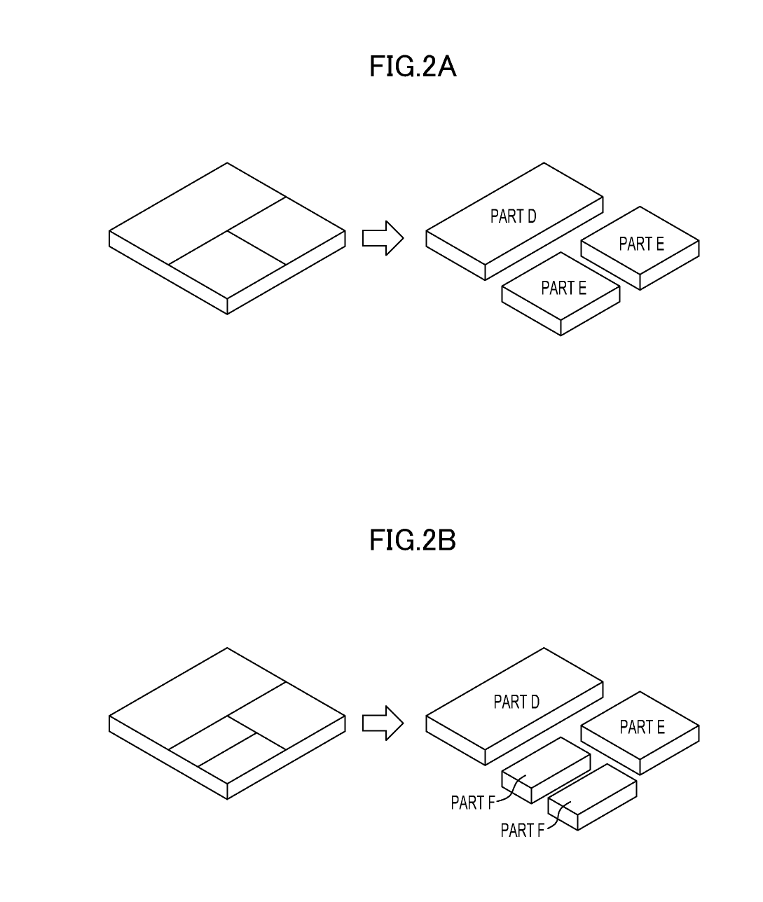

FIGS. 1A and 1B and FIGS. 2A and 2B are explanatory views illustrating examples to which a planning method according to the first embodiment of the present application may be applied.

FIGS. 1A and 1B illustrate examples of the case in which a plurality of parts, which are products, are concurrently produced by carrying out processing, such as press molding or casting, by using one die.

FIG. 1A illustrates an example of the case in which one unit of rectangular part A and two unit s of circular part B, which are illustrated on the right side, are produced at a time, that is, concurrently by using a die illustrated on the left side.

FIG. 1B illustrates an example of the case in which three unit s of part B and two unit s of triangular part C are produced at a time.

It is possible to appropriately design such a die. In addition to the illustrated examples, various patterns that allow one or a plurality of types of parts to be concurrently produced may be prepared.

For example, a die that produces two unit s of part A at a time, and a die that produces one unit of part B and six unit s of part C at a time, and various dies may be prepared.

FIGS. 2A and 2B illustrate examples of the case in which a plurality of different parts are produced by cutting one large material, such as a steel plate or cloth.

FIG. 2A illustrates an example of the case in which one unit of part D and two unit s of part E illustrated on the right side are produced at a time, that is, concurrently from a material illustrated on the left side.

FIG. 2B illustrates an example of the case in which one unit of part D, one unit of part E, and two units of part F are produced at a time.

In addition to the illustrated examples, various patterns that allow one or a plurality of types of parts to be concurrently produced may be prepared.

As has been mentioned, a planning method according to the first embodiment of the present application aids in creating a production plan by selecting a suitable production pattern when producing one or a plurality of types of parts that may be concurrently produced, and determining production time based on the selected production pattern.

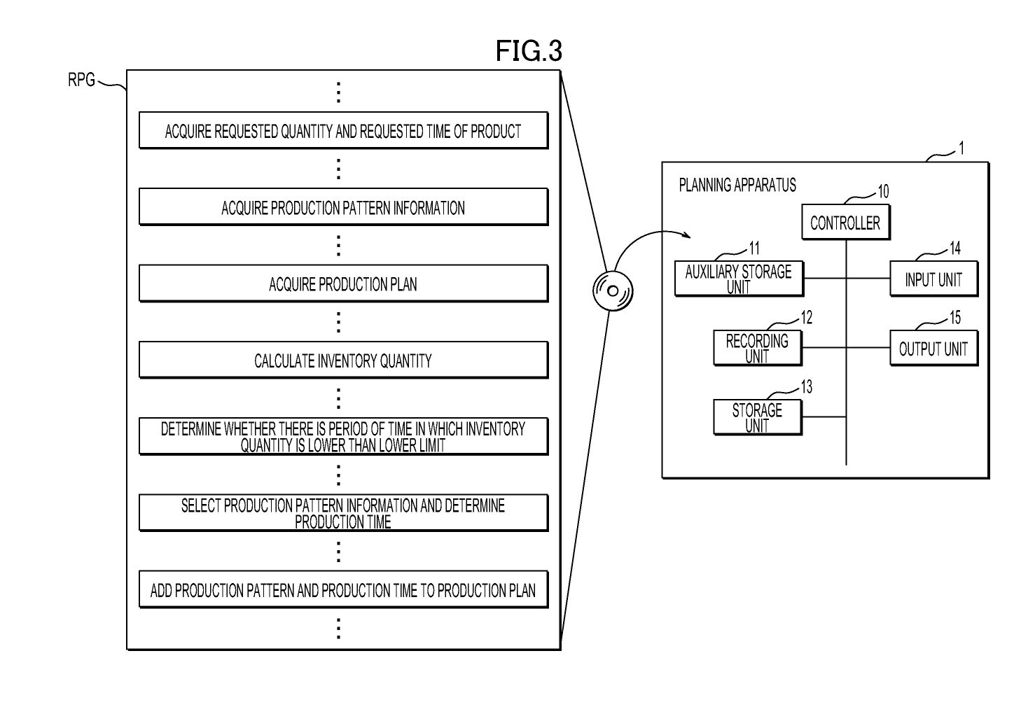

FIG. 3 is a block diagram illustrating a hardware configuration example of a planning apparatus 1 according to the first embodiment of the present application.

A production planning method according to the first embodiment of the present application may be implemented, for example, using the planning apparatus 1.

The planning apparatus 1 illustrated in FIG. 3 uses a computer such as a general purpose computer.

The planning apparatus 1 includes a controller 10, an auxiliary storage unit 11, a recording unit 12, a storage unit 13, an input unit 14 and an output unit 15.

The controller 10 is a device, such as a central processing unit (CPU), that controls the apparatus.

The auxiliary storage unit 11 is a device, such as an optical drive and other drives for various types of media, that reads various types of information from a recording medium, such as a compact disk read-only memory (CD-ROM), and a digital versatile disk (DVD)-ROM on which various types of information including programs, such as a planning program PRG for the planning apparatus 1 of the present application, and data are recorded.

The recording unit 12 is a device, such as a hard disk, that records various types of information read by the auxiliary storage unit 11.

The storage unit 13 is a device, such as a random access memory (RAM), that stores information temporarily produced by processing of the controller 10.

The input unit 14 is a device, such as a keyboard and a mouse, that accepts a user's input.

The output unit 15 is a device, such as a monitor and a printer, that outputs processed results.

By causing the planning program PRG recorded in the recording unit 12 to be stored in the storage unit 13 and executing the program by control of the controller 10, a computer operates as the planning apparatus 1.

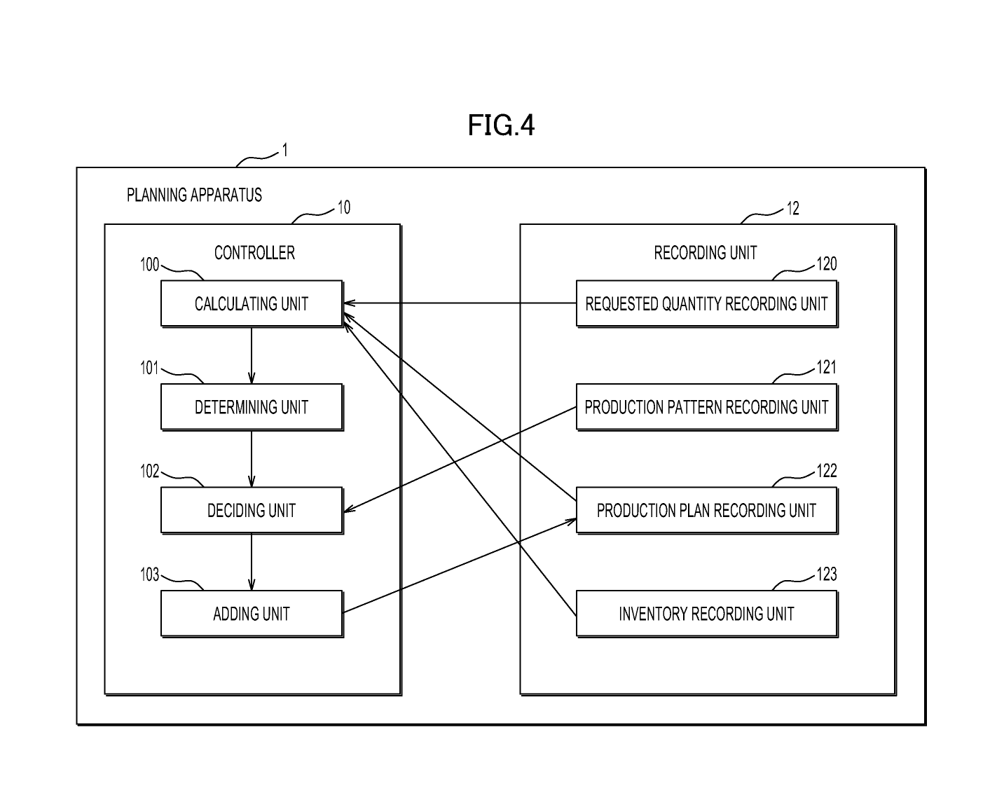

FIG. 4 is a functional block diagram illustrating a functional configuration example of the planning apparatus 1 of the first embodiment of the present application.

The planning apparatus 1 activates functions of a calculating unit 100, a determining unit 101, a deciding unit 102, an adding unit 103, and the like by executing the planning program PRG of the present application recorded in the recording unit 12 based on control of the controller 10.

The calculating unit 100 is a program module related to inventory quantity calculation. Inventory quantity calculation involves calculating the inventory quantity of various parts for every period of time, based on the requested quantity and requested time for parts as products and production plans.

The determining unit 101 is a program module that evaluates whether there is a period of time in which the calculated inventory quantity is lower than a previously set lower limit.

The deciding unit 102 is a program module related to a production pattern determination. In the production pattern determination, an appropriate production pattern is selected if it is determined that there is a period of time in which the calculated inventory quantity is lower than the lower limit, and the time at which production related to the selected production pattern is carried out is decided.

The adding unit 103 is a program module relevant to production plan addition. The production plan addition involves adding the determined production pattern and production time to the production plan.

The planning apparatus 1 executes the planning program PRG of the present application recorded in the recording unit 12 to enable the recording unit 12 to be used as an information recording area of a requested quantity recording unit 120, a production pattern recording unit 121, a production plan recording unit 122, an inventory recording unit 123, and the like.

Note that, without an information recording area as the various types of recording units being provided in the recording unit 12, various types of recording units may be provided in information recording areas of recording units that are included in other devices connected to the planning apparatus 1.

The requested quantity recording unit 120 is a database in which the requested quantity and requested time of a plurality of types of parts are recorded by type.

In the requested quantity recording unit 120, the requested quantity and requested time that indicates the due date of production are recorded for every type of part that is a product.

Note that the expression “requested quantity” is used herein for the sake of convenience. The unit for the “requested quantity” may be a unit of measure, such as weight, or a counting unit, such as a number, which is determined in accordance with the requested product.

In the requested quantity recording unit 120, requested quantity and requested time based on a request, such as an order from an outside source or a request from a downstream process, are recorded.

The production pattern recording unit 121 is a database in which a plurality of pieces of production pattern information representing production patterns that combine types of one or a plurality of types of parts being able to be concurrently produced and the production quantity of parts for every type are recorded.

The production patterns recorded as production pattern information in the production pattern recording unit 121 may be production patterns that have been described with reference to FIGS. 1A and 1B and FIGS. 2A and 2B.

In the production pattern recording unit 121, not only combinations of types of parts and production quantity but also various information including information on a required time period and required equipment in production related to the production pattern may be recorded.

The production plan recording unit 122 is a database in which production plans that combine production patterns and production times related to the production patterns are recorded.

Note that recorded in the production plan recording unit 122 are production plans in various states, such as a production plan that has been finally decided upon, a production plan that has been created by a planning method of the present application and that is awaiting a final decision, and a production plan in a state where a production pattern is temporarily arranged.

The inventory recording unit 123 is a database in which inventory information representing inventory quantity by type of parts as products is recorded.

The inventory information includes various information on storage of inventory, such as a storage place, of each product.

Next, processing of the planning apparatus 1 according to the first embodiment is described.

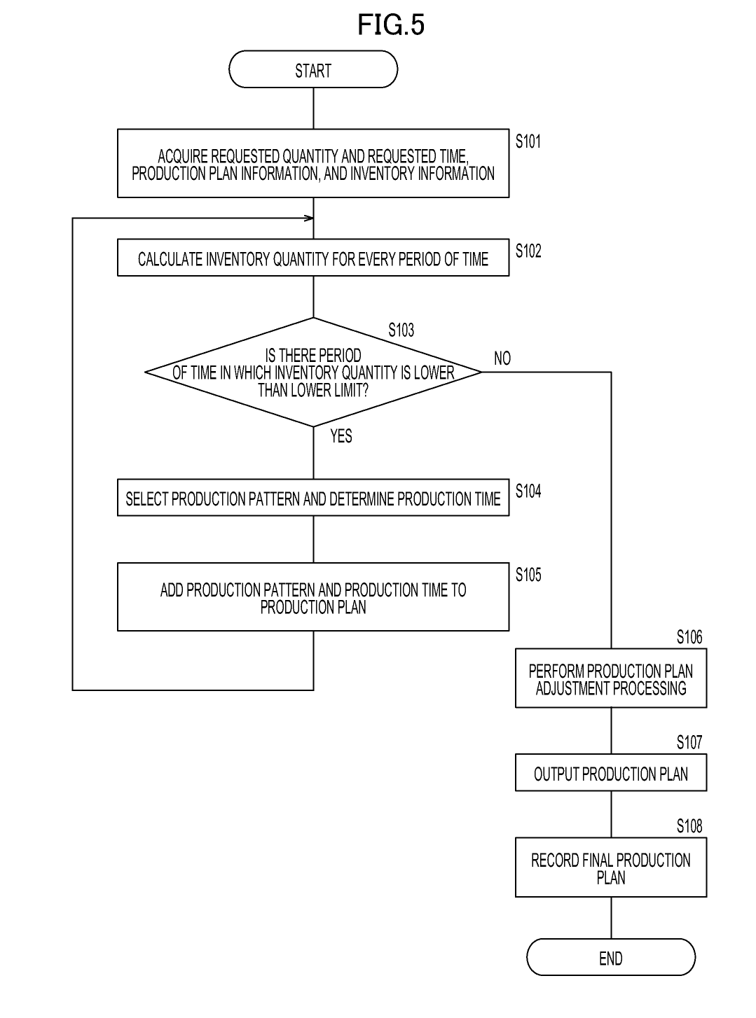

FIG. 5 is a flowchart illustrating an example of a planning process of the planning apparatus 1 according to the first embodiment of the present application.

Based on control of the controller 10 that executes the planning program PRG, the planning apparatus 1 acquires requested quantity and requested time of parts, information representing a production plan, and inventory information from the requested quantity recording unit 120, the production plan recording unit 122, and the inventory quantity recording unit 123 (S101).

The requested quantity and requested time of one or a plurality of types of parts by type are acquired from the requested quantity recording unit 120.

Information representing a production plan is acquired from the production plan recording unit 122.

A production plan that is finally decided upon is acquired at this stage. If the production plan is not finally decided upon at this stage, information representing a production plan with a blank in a column of a final production plan may be acquired.

Inventory information representing inventory quantity of parts for every type is acquired from the production plan recording unit 122.

Note that, if no inventory exists, inventory information indicating no inventory is acquired.

The planning apparatus 1 calculates inventory quantity for every period of time of each type of parts based on the requested quantity and requested time of each type of parts, the production plan, and the inventory information, by processing of the calculating unit 100 based on control of the controller 10 (S102).

In step S102, future changes in inventory quantity may be calculated.

In order to obtain changes in inventory quantity, an addition to the inventory quantity is performed based on the inventory of each type of parts that is recorded as inventory information, assuming that parts may be produced based on a production pattern in production time indicated in the production plan.

Further, a subtraction from the inventory quantity is performed assuming that the requested quantity of each type of parts will be shipped, transported to the location at which the subsequent process is to be performed, or carried out at the requested time.

In other words, for each type of product, based on the previously recorded inventory quantity, an accumulated value of the production quantities is added and an accumulated value of the requested quantities is subtracted, for every period of time, thereby calculating inventory quantity for every period of time.

In this way, in step S102, inventory quantity changes, which indicate inventory quantity for every period of time of each type of parts resulting from an addition and/or a subtraction for every period of time based on inventory of each type of parts that is recorded as inventory information, is calculated.

By processing of the determining unit 101 based on control of the controller 10, the planning apparatus 1 determines whether there is a period of time in which the inventory quantity, which is calculated based on a time, is lower than the lower limit (S103).

The lower limit is a value that is previously set. For example, a value of zero, which represents a state in which no inventory exists, may be set.

When zero is set as the lower limit, it is determined from changes in inventory quantity whether there is a period of time in which the inventory quantity has a negative value.

Note that, in order to prevent running out of stock due to an unforeseen factor such as an accident, a safe inventory quantity based on a value calculated using, for example, a statistical approach may be set as the lower limit.

If, in step S103, it is determined that there is a period of time in which the inventory quantity is lower than the lower limit (S103: YES), then the planning apparatus 1 selects a production pattern and determines production time by performing processing of the deciding unit 102 based on control of the controller 10 (S104).

The selection of a production pattern is processing of selecting one or a plurality of pieces of production pattern information to be incorporated into a production plan among a plurality of pieces of production pattern information recorded in the production pattern recording unit 121.

The determination of production time is processing of determining a time at which production according to a production pattern represented by the selected production pattern information is carried out.

Note that, a specific processing content of selecting a production pattern and determining production time is to be described later as a pattern determination process.

The planning apparatus 1 adds the decided production pattern and production time to a production plan recorded in the production plan recording unit 122 by processing of the adding unit 103 based on control of the controller 10 (S105).

At step S105, a temporary production plan, in which a production pattern is temporarily arranged, is created.

The planning apparatus 1 returns to step S102, and the subsequent processing is repeated.

At the time of recalculating inventory quantity when returning to step S102, inventory quantity of each type of part for every period of time is recalculated by using a temporary production plan to which a production pattern and production time have been newly added in step S105.

As such, the process from step S102 to step S105 is repeated until it is determined by the evaluating unit 101 that there is no period of time in which the inventory quantity is lower than the lower limit.

If, in step S103, it is determined that there is no period of time in which the inventory quantity is lower than the lower limit (S103: NO), the planning apparatus 1 performs adjustment processing of a production plan by control of the controller 10 (S106).

The adjustment processing includes interchanging the time of production patterns arranged as a temporary production plan, and the like.

For example, on condition that the production time is not later than the requested time, adjustment is performed to interchange the time of the temporarily arranged production patterns so as to produce such a production plan that the same production patterns are repeated.

This is for the purpose of suppressing reduction in production efficiency caused by changeover of production patterns.

By adjusting the temporary production plan, an interim production plan that is awaiting an instruction for final decision is produced.

The planning apparatus 1 outputs, from the output unit 15, the production plan whose adjustment processing has been carried out by control of the controller 10 (S107).

As processing of step S107, for example, the interim production plan is displayed on a monitor serving as the output unit 15.

An operator confirms the output interim production plan and inputs an instruction for final decision from the input unit 14.

Note that the operator may perform operation that modifies the interim production plan if desired.

A production plan may be finally decided upon without the artificial confirming of the production plan by the operator.

The planning apparatus 1 that has accepted the input of the instruction for final decision finally decides upon a production plan by control of the controller 10, and records the final production plan in the recording unit 122 (S108).

In this way, the planning process according to the first embodiment is performed.

A specific example of the planning process is described next.

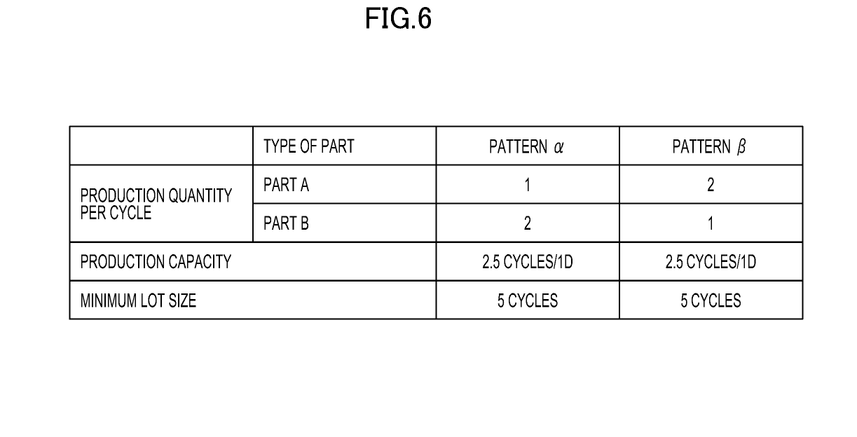

FIG. 6 is an explanatory view illustrating an example of a production pattern of a planning method according to the first embodiment of the present application.

In FIG. 6, an example of a production pattern recorded in the production pattern recording unit 121 is illustrated. The following specific example of the planning process is described as processing based on the production pattern exemplified in FIG. 6.

In an example illustrated in FIG. 6, pattern α and pattern β are illustrated as production patterns. Both pattern α and pattern β are production patterns for concurrently producing part A and part B.

Part A and part B are produced based on process time represented in cycle by using pattern α and pattern β.

In an example illustrated in FIG. 6, when production is carried out in pattern α, 1 unit of part A and 2 units of part B are produced in 1 cycle.

As production capacity, the number of cycles of production that may be carried out within a unit period D is indicated.

As the unit period D, a period such as day, time, or one third of a day (8 hours) may be set.

In the case of production in pattern α in the example illustrated in FIG. 6, production in 2.5 cycles may be carried out in one unit period D, that is, the period of 1D.

In other words, in the period of 1D, 1×2.5 cycles=2.5 units of part A and 2×2.5 cycles=5 units of part B may be produced.

A minimum lot size represents a minimum value of the number of cycles in which continuous production is required.

The example illustrated in FIG. 6 represents that, when production is started in pattern α, continuous production of 5 cycles or more is needed.

Accordingly, after the start of production, continuous production equal to or greater than 5 cycles÷2.5 cycle/1D=2D is required. In the period of 2D, 1×5 cycles=5 units of part A and 2×5 cycles=10 units of part B are produced.

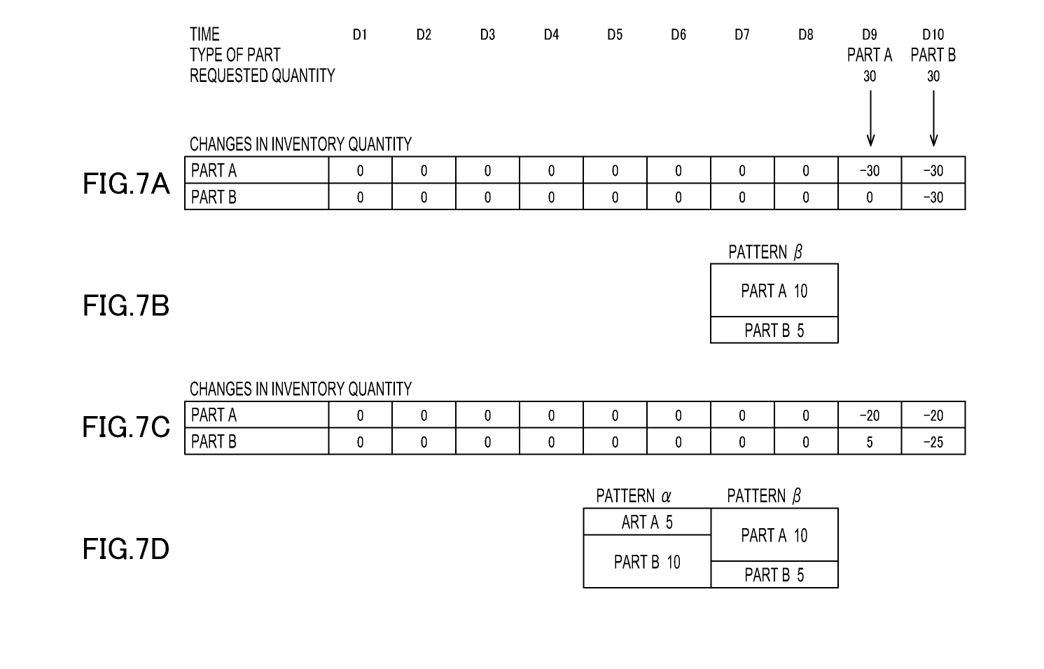

FIGS. 7A to 9C are explanatory views illustrating specific examples of a planning method according to the first embodiment of the present application.

In FIGS. 7A to 9C, changes in inventory quantity of part A and part B or production time according to production patterns are illustrated by time, that is, in unit period D.

FIGS. 7A and 7B illustrate a stage where processing from step S101 to step S105 has first been performed.

The requested quantity and the requested time of parts acquired in step S101 are 30 units and time D9 for part A, and 30 units and time D10 for part B.

Note that it is assumed that no inventory exists at time D1.

By calculating inventory quantity for every period of time of each type of part in step S102, the inventory quantity of part A is −30 units at and after time D9, and the inventory quantity of part B is −30 units at and after time D10.

Changes in inventory quantity of each type of the calculated part for every period of time are illustrated in a table of FIG. 7A.

Here, assuming that the lower limit is set to zero, it is determined in step S103 that there is a period of time in which the inventory quantity is lower than the lower limit.

In step S104, it is determined that production of pattern β is carried out so that the production is to be completed by time D9. In step S105, the production of pattern β is added to the production plan.

The production plan after the addition of the production of pattern β, that is, a temporary production plan that represents production according to pattern β and time according to pattern β is illustrated in FIG. 7B.

FIGS. 7C and 7D illustrate a stage where processing from step S102 to step S105 (FIG. 5) is further performed after the production of the pattern β has been added so as to achieve the temporary production plan illustrated in FIG. 7B.

Based on the temporary production plan illustrated in FIG. 7B, changes in inventory quantity of each type of part calculated for every period of time in step S102 are illustrated in a table of FIG. 7C.

At this stage, it is also determined in step S103 that there is a period of time in which the inventory quantity is lower than the lower limit.

In step S104, it is determined that production of pattern α is carried out so that the production is to be completed by time D9. In step S105, the production of pattern α is added to the production plan.

Note that, here, the production plan is created assuming that one piece of production equipment is used.

Accordingly, since production according to pattern β is already arranged in the temporary production plan illustrated in FIG. 7B, production of the pattern α determined this time is added before the production of pattern β.

The temporary production plan after the addition of the production of pattern α is illustrated in FIG. 7D.

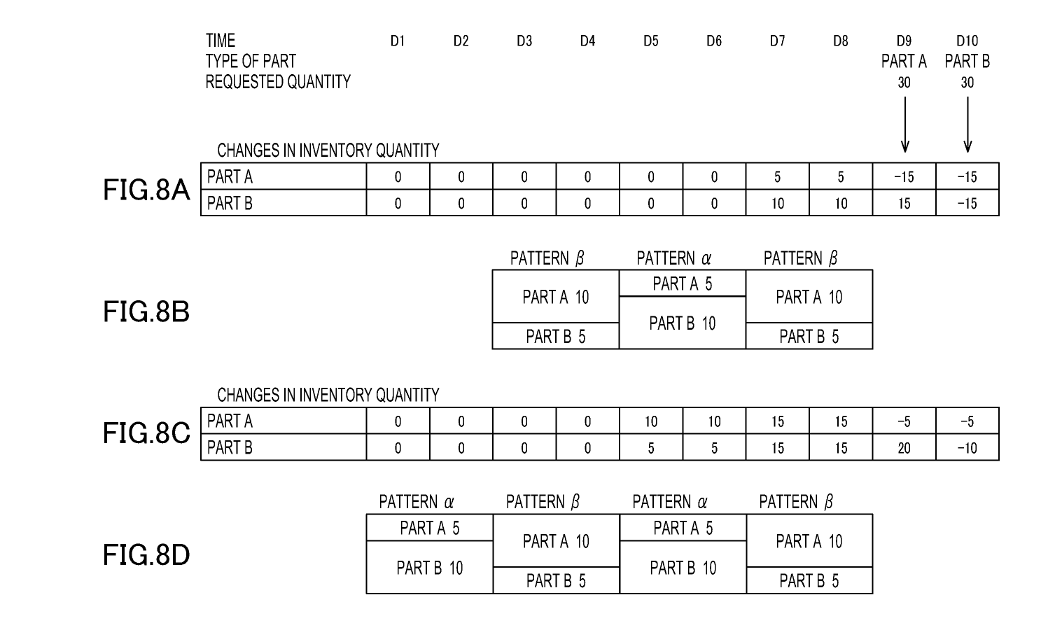

FIGS. 8A and 8B illustrate a state at a stage where processing from step S102 to step S105 is further performed, after the production of the pattern α has been added so as to achieve the temporary production plan illustrated in FIG. 7D.

Based on the temporary production plan illustrated in FIG. 7D, changes in inventory quantity of each type of part calculated for every period of time in step S102 are illustrated in a table of FIG. 8A.

The temporary production plan after production of pattern β has been added to it in step S105 is illustrated in FIG. 8B.

FIGS. 8C and 8D illustrate a stage where processing from step S102 to step S105 is further performed, after the production of pattern β has been added so as to achieve the temporary production plan illustrated in FIG. 8B.

Based on the temporary production plan illustrated in FIG. 8B, changes in inventory quantity of each type of part calculated for every period of time in step S102 are illustrated in a table of FIG. 8C.

The temporary production plan after production of pattern α has been added in step S105 is illustrated in FIG. 8D.

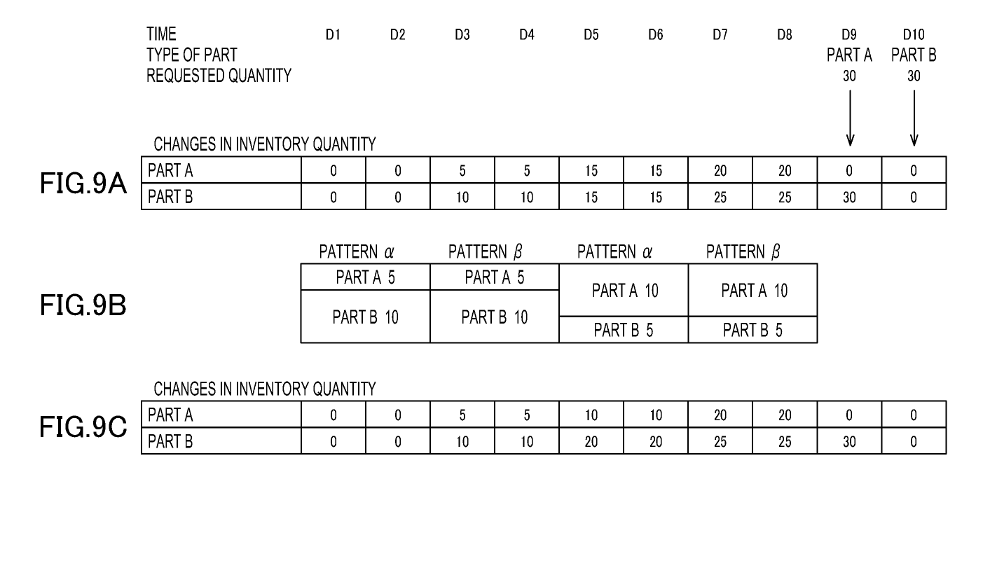

FIG. 9A is a table illustrating changes in inventory quantity of each type of part calculated for every period of time in step S102, based on the temporary production plan illustrated in FIG. 8D after the production of pattern α has been added so as to achieve the temporary production plan illustrated in FIG. 8D.

In changes in inventory quantity illustrated in FIG. 9A, there is no period of time in which values of inventory quantity of part A and part B are negative.

Accordingly, in step S103, it is determined that there is no period of time in which the inventory quantity is lower than the lower limit.

FIG. 9B illustrates the temporary production plan at a stage where adjustment processing has been performed in step S106 after it is determined in step S103 that there is no period of time in which the inventory quantity is lower than the lower limit.

FIG. 9C illustrates changes in inventory quantity of each type of part calculated for every period of time, which are obtained by recalculation at a stage where adjustment processing in step S106 has been performed.

Here, as the adjustment processing of the production plan, the production order is changed so as to repeat the same production patterns.

The adjustment processing is performed so as to repeat the same production patterns within the range where, in inventory changes, there is no inventory quantity lower than the lower limit. Reduction in production efficiency that is caused by changeover of production patterns may thereby be reduced if not prevented.

Note that, regarding the number of same production pattern repetitions, it is possible to provide the upper limits of the number of days, the number of cycles and the number of lots, such as up to how many days, up to how many cycles, and up to how many lots.

It is also possible to make an appropriate design so that a recommended changeover order of production patterns and a changeover order of production patterns to be avoided are previously registered, and, based on the registered changeover orders, an interchange is performed in the range where, in inventory changes, there is no inventory quantity lower than the lower limit.

The planning apparatus 1, which performs a planning method of the present application, outputs the created production plan as the interim production plan in step S107. After accepting input of an instruction of final decision, the planning apparatus 1 records the production plan finally decided upon in the production plan recording unit 122 in step S108.

In examples explained with reference to FIGS. 6 to 9C, a production plan is created assuming that one piece of production equipment is used. However, a production plan may be suited to the use of a plurality of pieces of production equipment.

If, as a result of arrangement of a production pattern, time at which production is to be carried out is arranged before a preset date at which production may be started, such as production time arranged before the date at which the plan is created, production according to the production pattern may not be carried out at the arranged production time.

To avoid such a situation, hypothetical production equipment is set a head of time, and production according to the production pattern may be assigned to the hypothetical production equipment.

After producing an interim production plan, an operator preferably performs appropriate adjustment.

Presetting hypothetical production equipment helps to reduce or prevent the creation of an impractical production plan and problems, such as an infinite loop, associated with the plan.

The pattern determination process according to the first embodiment is next described.

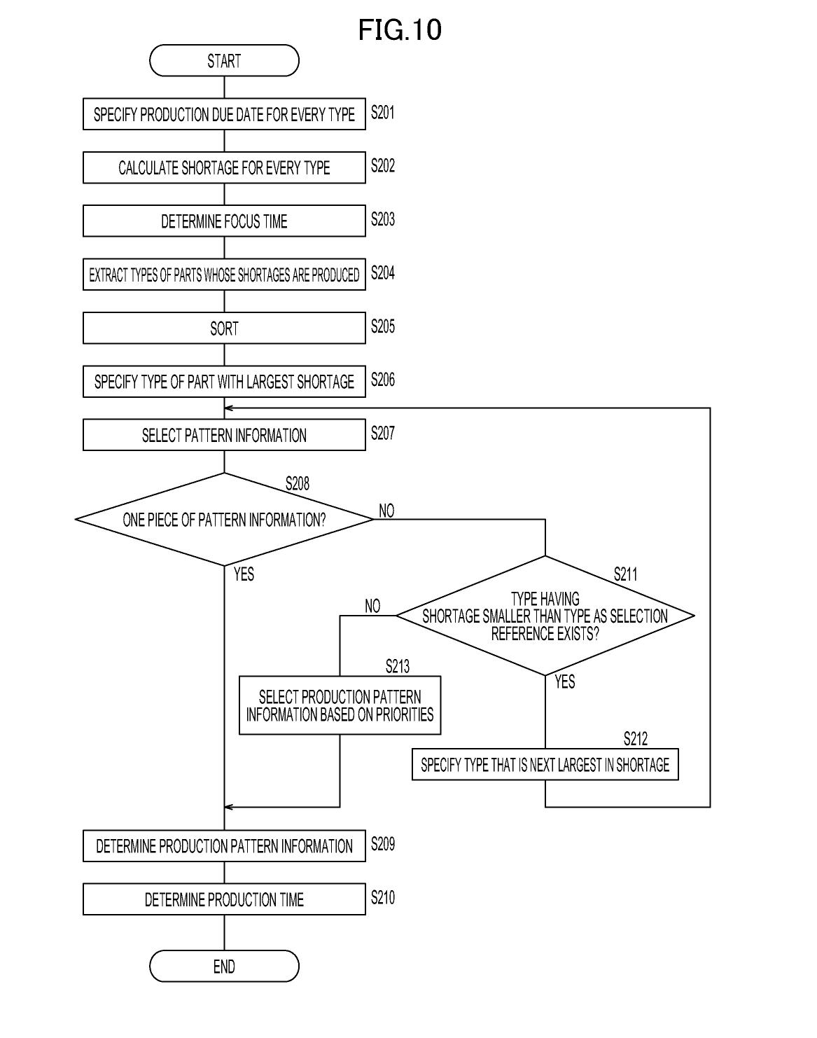

FIG. 10 is a flowchart illustrating an example of the pattern determination process of the planning apparatus 1 according to the first embodiment of the present application.

The pattern determination process is processing that performs the selection of a production pattern and the determination of production time in step S104 of the planning process described with reference to FIG. 5.

The planning apparatus 1 specifies a due date of production representing a period of time in which the inventory quantity calculated by the calculating unit 100 first becomes lower than the lower limit, for every type of part as a product, by processing of the deciding unit 102 based on control of the controller 10 that executes the planning program PRG (S201).

The inventory quantity calculated by the calculating unit 100 is an inventory quantity of each type of part for every period of time that is calculated in step S102 of the planning process with reference to FIG. 5.

Using the controller 10, the planning apparatus 1 calculates a shortage representing a difference between the lower limit and the inventory quantity at the specified due date of production, for every type of part (S202), and the due date of production of a type of part whose calculated shortage is the largest among all types of parts is determined as a focus time (S203).

The shortage, as the term is used herein, indicates an amount representing how much the inventory quantity is lower than the lower limit.

In step S203, a type of part whose shortage is the largest among all types of parts is specified, and the due date of production specified in step S201 for the specified type of part is determined as the focus time.

By using control of the controller 10, the planning apparatus 1 extracts types of parts whose shortages are produced at the determined focus time (S204).

In step S204, types of parts each of which has an inventory quantity equal to or lower than the lower limit at the focus time are extracted.

By using control of the controller 10, the planning apparatus 1 sorts extracted types of parts in descending order of shortage at the focus time (S205), and specifies a type of part whose shortage at the focus time is largest among the sorted types of parts (S206).

By using control of the controller 10, the planning apparatus 1 selects, for the specified type of part, pattern information representing a production pattern in which the production quantity of the type of part is largest among production patterns (S207).

In step S207, one or a plurality of pieces of production pattern information are selected from among a plurality of pieces of production pattern information recorded in the production pattern recording unit 121.

By using control of the controller 10, the planning apparatus 1 determines whether one piece of pattern information is selected or a plurality of pieces of pattern information is selected (S208).

If, in step S208, it is determined that one piece of pattern information is selected (S208: YES), then the planning apparatus 1 determines, by using control of the controller 10, the pattern information as the production pattern information selected by the deciding unit 102 (S209).

By using control of the controller 10, the planning apparatus 1 determines that production time according to the production pattern represented by the determined production pattern information is the earliest time on and before the due date of production among due dates of production according to the type of part produced in the production pattern in question (S210).

In step S210, the earliest due date of production among all types of produced parts is specified, and the production time is determined so that production according to the determined production pattern is finished before the specified due date of production.

Note that in cases where a production plan according to a production pattern has already been placed at the determined production time, the production time is to be shifted so that the production according to the determined production pattern is finished before the start of the placed production plan.

After the production pattern and the production time are determined, the planning apparatus 1 finishes the pattern determination process and performs processing in and after step S105 of the planning process.

If, in step S208, it is determined that the number of pieces of pattern information is more than one (S208: NO), the planning apparatus 1 determines, by using control of the controller 10, whether there is a type of part whose shortage is smaller than the type of part used as the reference of selection (S211).

In step S211, it is determined whether there is a type of part whose shortage is smaller than the type of part used as the reference of the previous selection in step S207.

For example, in cases where pattern information is selected based on production quantity of the type of part whose shortage at the focus time is largest in the previous processing of step S207, it is determined whether there is a type of part that is next largest in shortage at the focus time.

For the determination, the result of sorting in step S205 is used.

If, in step S211, it is determined that there is a type of part that meets the requirement (S211: YES), the planning apparatus 1 specifies, by using control of the controller 10, a type of part that is next largest in shortage, after the type of part used as the reference of selection (S212).

For example, in cases where pattern information is selected based on the production quantity of the type of part whose shortage at the focus time is largest in the previous processing of step S207, a type of part that is next largest in shortage at the focus time is specified.

For the specification, the result of sorting in step S205 is used.

By using control of the controller 10, the planning apparatus 1 proceeds to step S207, and repeats the subsequent processing.

Note that, in step S207, pattern information indicating a production pattern that is largest in production quantity of the type of part specified in step S212 is selected from among a plurality of pieces of pattern information selected in the previous processing of step S207.

If, in step S211, it is determined that there is no type of part that meets the requirement (S211: NO), then the planning apparatus 1 selects, by using control of the controller 10, one piece of production pattern information based on priorities that are preset for production patterns (S213).

In step S213, one piece of production pattern information having top priority is selected from among the plurality of pieces of pattern information selected in the previous processing of step S207.

By using control of the controller 10, the planning apparatus 1 proceeds to step S209, determines one piece of production pattern information selected in step S213 as the production pattern information selected by the deciding unit 102 (S209), and repeats the subsequent processing.

In this way, the pattern determination process is performed.

A specific example of the pattern determination process is described next.

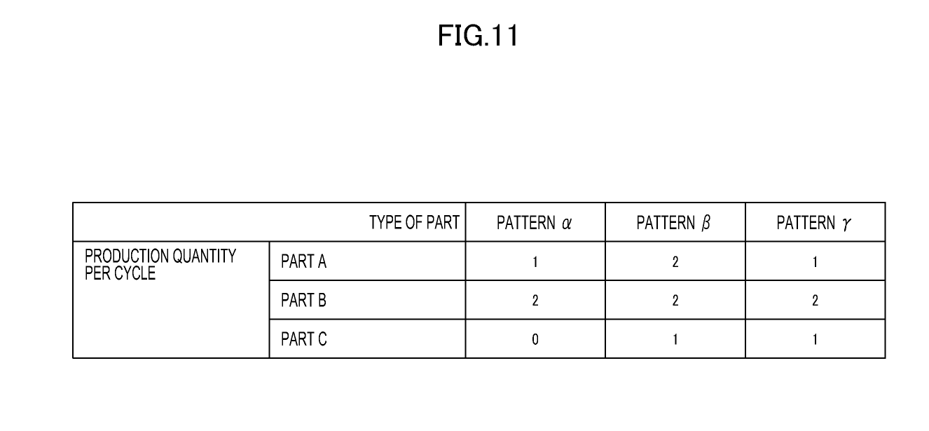

FIG. 11 is an explanatory view illustrating an example of a production pattern of the planning method according to the first embodiment of the present application.

FIG. 11 illustrates an example of a production pattern recorded in the production pattern recording unit 121, and the following specific example of the pattern determination process is described as processing based on the production pattern exemplified in FIG. 11.

In the example illustrated in FIG. 11, pattern α, pattern β, and pattern γ are illustrated as production patterns.

Pattern α is a production pattern for concurrently producing one unit of part A, and two units of part B.

Pattern β is a production pattern for concurrently producing two units of part A, two units of part B, and one unit of part C.

Pattern γ is a production pattern for concurrently producing one unit of part A, two units of part B, and one unit of part C.

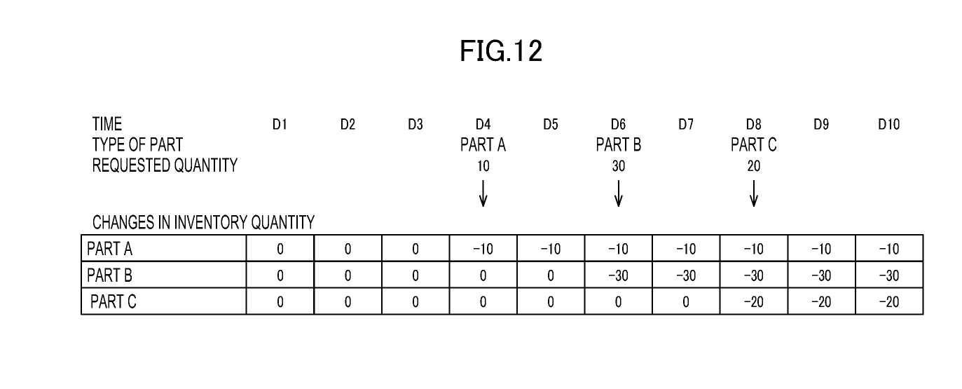

FIG. 12 is an explanatory view illustrating a specific example of the production pattern of the planning method according to the first embodiment of the present application.

In FIG. 12, changes in inventory quantity of part A, part B, and part C for every period of time represented using the unit period D are illustrated.

FIG. 12 illustrates a stage where processing in steps S101 to S103 of the planning process has been performed.

The requested quantity and the requested time of parts acquired in step S101 are 10 units and time D4 for part A, 30 units and time D6 for part B, and 20 units and time D8 for part C, respectively.

Note that it is assumed that no inventory exists at time D1.

By calculating an inventory quantity for every period of time of each type of part in step S102, the inventory quantity of part A is −10 units at and after time D4, the inventory quantity of part B is −30 units at and after time D6, and the inventory quantity of part C is −20 units at and after time D8.

Here, assuming that the lower limit is set to zero, it is determined in step S103 that there is a period of time in which the inventory quantity is lower than the lower limit.

The following pattern determination process is performed.

In step S201, a due date of production representing a time at which the inventory quantity first becomes lower than the lower limit is specified for every type of part.

Here, time D4 is specified for part A, time D6 is specified for part B, and time D8 is specified for part C.

In step S202, the shortage is calculated for every type of part at the due date of production.

Here, the calculated shortages are −10 units at time D4 for part A, −30 units at time D6 for part B, and −20 units at time D8 for part C.

Accordingly, in step S203, time D6, or the due date of production for part B, at which the shortage is largest is determined as the focus time.

In step S204, part A as well as part B are extracted as types of parts for which the shortages are produced at the focus time.

By the processing in steps S205 to S206, part B that is largest in shortage at the focus time is specified. In step S207, pattern β and pattern γ are selected as production patterns that are largest in production quantity of part B.

Since a plurality of production patterns have been selected, pattern β is selected between pattern β and pattern γ, based on production quantity of part A that is the next largest in shortage at the focus time, in second processing of step S207.

Pattern β selected in the second processing in step S207 is determined in step S209 as the production pattern information selected by the deciding unit 102.

Since the earliest due date of production among due dates of production of part A, part B, and part C produced in pattern β is time D4 of part A, the production time is determined, in processing in step S210, so that production in pattern β is finished at the time at and after time D4.

Note that, at the time of selecting a production pattern, it is possible to select a more efficient production pattern by adding various conditions to the exemplified pattern determination process.

For example, a production pattern having a production quantity that is excessively large relative to the shortage may be excluded from production patterns targeted for selection.

Specifically, in the case of a shortage of 1 unit, unnecessary inventory may be reduced if not prevented by excluding a production pattern having production quantity of 100 units.

As described in detail above, a planning process according to the planning method of the present application relates to planning production that concurrently produces a plurality of types of products.

The pattern determination process of the present application may perform preferable selection of a production pattern and determination of production time in the case of concurrently producing a plurality of types of products.

That is, at the time of selecting a production pattern and determining production time, applying the pattern determination process of the present application causes the planning method of the present application to produce desirable effects, such as enabling creation of a more efficient production plan with a balance between a production quantity and production time of a plurality of types of products taken into account.

For example, like conventional required quantity calculations, when, merely from changes in inventory of a single product, a production pattern including the single product is determined based on priorities and the like, there is a possibility of planning inefficient production that produces unnecessary products to increase useless inventory.

In contrast, as previously described, the pattern determination process of the present application may determine a more efficient combination even in a local production pattern selection with unexpected situations of a plurality of products taken into account.

The foregoing first embodiment merely exemplifies part of infinite embodiments of the present application, and it is possible to design configurations of various types of hardware and software, and the like as appropriate in accordance with the purposes, applications, and the like.

It is also possible to apply the planning method of the present application to various types of production other than the exemplified production.

Moreover, while the word “production” is used, the planning method of the present application may be applied assuming that the production as used herein represents one process among a plurality of processes required for manufacturing a product.

Specifically, the method may be applied to processes, such as heat treatment processes in ovens and painting processes that concurrently process a plurality of parts. In this case, for example, in planning of a heat treatment for a plurality of parts by a due date of production, efficient using of an oven may support determinations of a pattern and production time.

It is also possible in the planning method of the present application to sequentially add new production patterns.

At the time of planning a new production pattern, it is also possible to make developments so as to propose an efficient production pattern, for example, based on actual planning results in the past, by processing of the planning apparatus.

In the production patterns in the planning method of the present application, production patterns in the type of production in view of the circumstances, such as the convenience of the manufacturing side and future demand forecasting, in accordance with the factors, such as factories, equipment, products and materials, are prepared in advance.

However, in cases where the type of production pattern is not suited to the demand, a situation in which manufacturing in the prepared production patterns is inefficient might occur.

For example, assume that there is merely a production pattern of one unit of product A and two units of product B as a production pattern that concurrently produces product A and product B.

If the cumulative ratio of desired quantities of products between product A and product B is 1 to 1 under such an assumption, a plan of production that produces a useless quantity of product B is created. This leads to a large quantity of unnecessary inventory.

When such a plan is created, the planning apparatus may propose, to an operator, a candidate for the production pattern that keeps up with demand, which is a production pattern with a ratio between product A and product B of 1:1 in the case of this example.

Further, the planning apparatus may automatically make additional registration of the production pattern, and may perform again the foregoing processes so as to simulate a production plan.

### SECOND EMBODIMENT

In a second embodiment, the planning method described in the first embodiment may be applied to a system other than the system capable of creating the product production plan.

The planning method of the present application may be applied to creating an assignment plan of a plurality of assignment objects assignable in parallel.

For example, creating plans, such as loading plans of baggage in the transportation industry and arrangement plans of ceramics in kilns in the ceramic industry, may be exemplified.

The hardware configuration of a planning apparatus according to the second embodiment is similar to the first embodiment.

Note that the same configurations as in the first embodiment are denoted by the same reference characters as in the first embodiment, the first embodiment is referred to, and description of the same configurations is omitted.

Note also that for the configurations corresponding to configurations in the first embodiment, the first embodiment is referred to, and a detailed description is omitted.

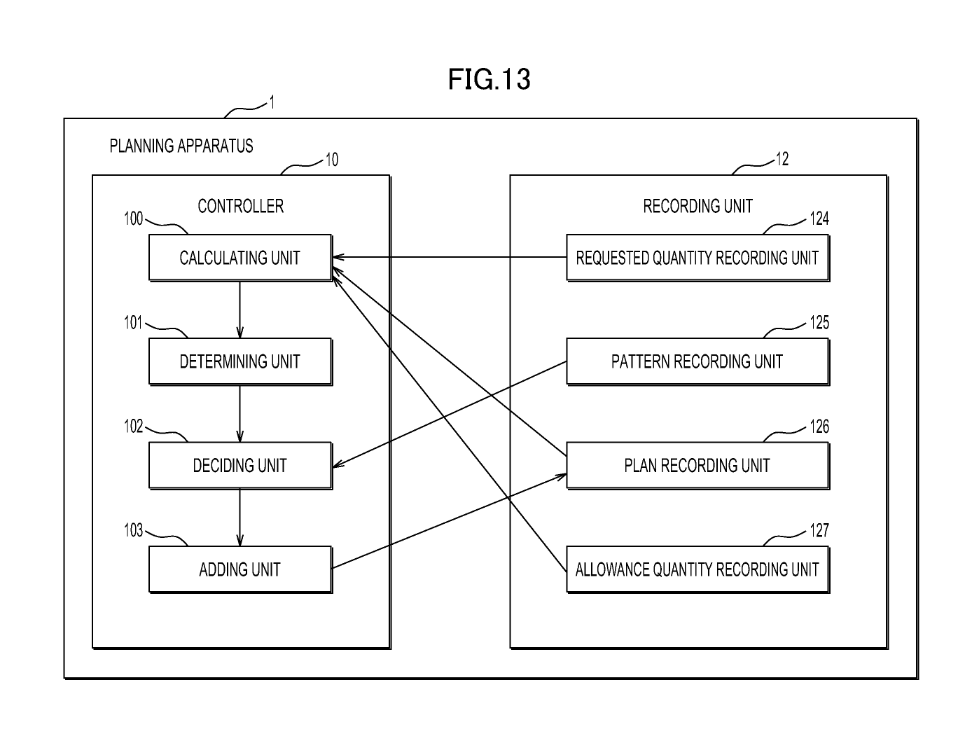

FIG. 13 is a functional block diagram illustrating a functional configuration example of the planning apparatus 1 according to the second embodiment of the present application.

The planning apparatus 1 executes the planning program PRG of the present application recorded in the recording unit 12 to operate functions of the calculating unit 100, the determining unit 101, the deciding unit 102, the adding unit 103, and the like.

These functions are substantially the same as the functions in the first embodiment.

The planning apparatus 1 also executes the planning program PRG recorded in the recording unit 12 to make the recording unit 12 available as an information recording area for a requested quantity recording unit 124, a pattern recording unit 125, a plan recording unit 126, an allowance quantity recording unit 127, and the like.

The requested quantity recording unit 124 is a database having recorded therein requested quantities of a plurality of types of assignment objects which are requested to be assigned, and due dates of assignments.

The requested quantity recording unit 124 corresponds to the requested quantity recording unit 120 according to the first embodiment.

The pattern recording unit 125 is a database in which a plurality of pieces of assignment pattern information each representing an assignment pattern that combines the type of one or a plurality of types of assignment objects assignable concurrently and an assignment quantity of the assignment objects for every type, are recorded.

The pattern recording unit 125 corresponds to the production pattern recording unit 121 according to the first embodiment, and the assignment pattern corresponds to the production pattern according to the first embodiment.

The plan recording unit 126 is a database in which assignment plans each combining an assignment pattern and an assignment period of time according to the assignment pattern are recorded.

The plan recording unit 126 corresponds to the production plan recording unit 122 according to the first embodiment.

The allowance quantity recording unit 127 is a database in which allowance quantity information representing an allowance quantity of an assignment object is recorded.

The allowance quantity of an assignment object, as the term is used herein, indicates an amount calculated by subtracting the accumulated value of the requested quantities from the accumulated value of the assignment quantities for each assignment object for every period of time.

The allowance quantity recording unit 127 corresponds to the inventory quantity recording unit 123 according to the first embodiment, and the allowance quantity corresponds to the inventory quantity according to the first embodiment.

Processing of the planning apparatus 1 according to the second embodiment is described.

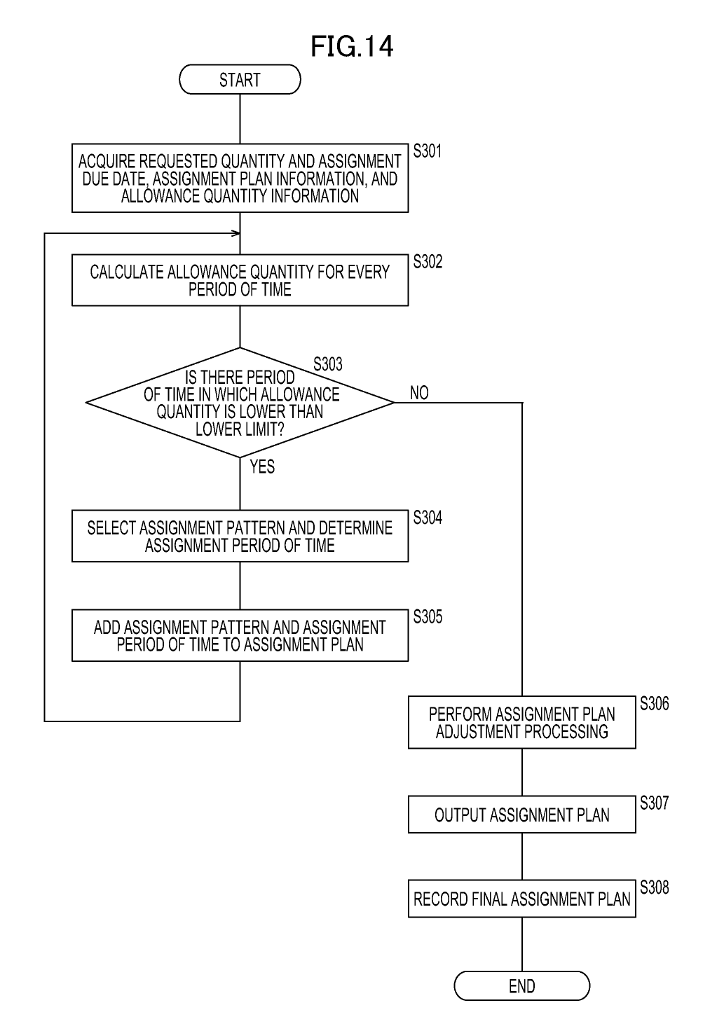

FIG. 14 is a flowchart illustrating an example of a planning process of the planning apparatus 1 according to the second embodiment of the present application.

Based on control of the controller 10 that executes the planning program PRG, the planning apparatus 1 operates functions of the calculating unit 100, the determining unit 101, the deciding unit 102, the adding unit 103, and the like, to perform the following processing.

The planning apparatus 1 acquires requested quantities of assignment objects which are requested to be assigned and due dates of assignments, and information representing an assignment plan and allowance quantity information, from the requested quantity recording unit 124, the plan recording unit 126, and the allowance quantity recording unit 127 (S301).

The planning apparatus 1 calculates an allowance quantity of each type of assignment objects for every period of time based on the requested quantity of each type of assignment objects and the due date of an assignment, the assignment plan, and the allowance quantity information (S302), and determines whether there is a period of time in which the allowance quantity for every period of time is lower than the preset lower limit (S303).

If, in step S303, it is determined that there is a period of time in which the allowance quantity is lower than the lower limit (S303: YES), the planning apparatus 1 selects an assignment pattern and determines an assignment period of time (S304).

The selection of the pattern is processing of selecting one or a plurality of pieces of production pattern information to be incorporated into a production plan from among a plurality of pieces of assignment pattern information that are recorded in the pattern recording unit 125.

The determination of the assignment period of time is processing for determining a period of time in which production according to an assignment pattern represented by the selected assignment pattern information is carried out.

The planning apparatus 1 adds the determined assignment pattern and assignment period of time to the assignment plan recoded in the plan recording unit 126 (S305), and the process returns to step S302 and repeats the subsequent processing.

At the time of recalculation of an allowance quantity at a stage where the process returns to step S302, recalculation of allowance quantities of each type of assignment objects for every period of time is performed using a temporary assignment plan to which the assignment pattern and the assignment period of time have been newly added in step S305.

Accordingly, processing from step S302 to step S305 is repeated until it is determined that there is no period of time in which the allowance quantity is lower than the lower limit.

If it is determined in step S303 that there is no period of time in which the allowance quantity is lower than the lower limit (S303: NO), the planning apparatus 1 performs adjustment processing of the assignment plan (S306).

The assignment plan whose adjustment processing has been performed is output from the output unit 15 (S307).

After the planning apparatus 1 finally decides upon the assignment plan, the assignment plan finally decided upon is recorded in the plan recording unit 126 (S308).

Processing in steps S301 to S308 of the planning process according to the second embodiment corresponds to processing in steps S101 to S108 of the planning process according to the first embodiment.

In this way, the planning process according to the second embodiment is performed.

The planning apparatus 1 according to the second embodiment of the present application performs a pattern determination process as processing of the selection of an assignment pattern and the determination of an assignment period of time in step S304 of the planning process that has been described with reference to FIG. 14.

The pattern determination process according to the second embodiment corresponds to the pattern determination process according to the first embodiment, and the processes are substantially the same. Therefore, the first embodiment is referred to, and the descriptions of the same processes are omitted.

A specific example of the planning method according to the second embodiment is next described.

It is possible to apply a planning method according to the second embodiment of the present application, for example, to create a loading plan to load cars on car ferries.

In the case of applying the planning method to the loading plan of car ferries, assignment objects are vehicles, and the types of assignment objects are classified into large-sized motor vehicles, medium-sized motor vehicles, ordinary motor vehicles, large-sized special motor vehicles, ordinary motorcycles, large-sized motorcycles, and the like.

The period of time related to assignment is the sailing time of the car ferry.

Thus, by applying the planning method according to the present application to the loading plan of car ferries, the planning method according to the present application enables an efficient transportation plan to be created.

It is also possible to apply a planning method according to the present application to support of creating a loading plan of baggage related to other transportation industries, such as transportation of cargo other than vehicles, and further to air transportation and land transportation other than marine transportation.

It is possible to apply a planning method according to the second embodiment of the present application, for example, to create a plan, such as a plan of arrangement of ceramics in kilns in the ceramic industries.

In the case of applying the planning method to arrangement in kilns, assignment objects are ceramics before quenching, and types of assignment objects are tea bowls, dishes and cups, and further roof tiles, pots, glass sculptures, etc.

Thus, by applying the planning method according to the present application to the arrangement plan in kilns, the planning method according to the present application enables an efficient plan to be created.

It is also possible to apply a planning method according to the present application to support of creating other arrangement plans other than those in the ceramic industries.

Furthermore, it is possible to apply a planning method according to the second embodiment of the present application to creating an installation plan of a production line in a production process made up of working processes at multiple stages.

For example, at the time of installing a production line for producing products through a plurality of processes, such as cutting, bonding, modification, assembling, and inspection, it is possible to apply the planning method to create an installation plan of a production line when changing a production line for the purpose of production of another type of product.

In the case of applying the planning method to installation of a production line, assignment objects are equipment and tools required for each process, and types of assignment objects are equipment and tools required for processes, such as bonding of part A, bonding of part B, and assembling of part C and part D.

Thus, by applying the planning method to an installation plan of a production line, the planning method according to the present application enables an efficient installation plan to be created.

It is also possible to use a planning method according to the present application for creating a plan of arranging persons having a specific skill, quality, or qualification other than equipment and tools.

The foregoing second embodiment merely exemplifies part of the infinite embodiments of the present application, and it is possible to design configurations of various types of hardware and software, and the like as appropriate in accordance with the purposes, applications, and the like.

It is possible to add necessary conditions as appropriate to support creating a more efficient plan.

Further, it is possible to apply a planning method of the present application to planning in various fields other than those exemplified in the foregoing embodiments.

What is claimed is:

1. A planning apparatus comprising:
a requested quantity recording unit that records requested quantities of a plurality of types of assignment objects which are requested to be assigned and due dates of assignment;
a pattern recording unit that records a plurality of pieces of assignment pattern information indicating an assignment pattern that combines at least one type of assignment object and an assignment quantity of every type of assignment object;
a plan recording unit that records an assignment plan combining the assignment pattern and an assignment time period related to the assignment pattern;
a calculating unit that calculates an allowance quantity of each assignment object for every time period by subtracting an accumulated value of requested quantities from an accumulated value of assignment quantities, based on the requested quantity of an assignment object requested to be assigned and the due date of an assignment, the requested quantity and the due date of an assignment being recorded by the requested quantity recording unit, and the assignment plan recorded by the plan recording unit;
a determining unit that determines whether there is a time period in which the allowance quantity calculated by the calculating unit is lower than a preset lower limit;
an assignment pattern determining unit that selects at least one piece of assignment pattern information among the plurality of pieces of assignment pattern information recorded by the pattern recording unit if the determining unit has determined that there is a time period in which the allowance quantity is lower than the preset lower limit, and that determines an assignment time period related to the assignment pattern indicated by the selected at least one piece of assignment pattern information; and
a plan adding unit that adds the assignment pattern and the assignment time period determined by the assignment pattern determining unit to the assignment plan recorded by the plan recording unit.

2. The planning apparatus according to claim 1, wherein the assignment pattern determining unit comprises:
a specifying unit that specifies, for each type of assignment object, an assignment due date that indicates a time period in which the allowance quantity calculated by the calculating unit first becomes lower than the preset lower limit;
a shortage calculating unit that calculates, for each type of assignment object, a shortage that indicates a difference between the preset lower limit and the allowance quantity at the specified assignment due date;
an assignment selection unit that selects assignment pattern information that indicates an assignment pattern in which a type of assignment object with the largest calculated shortage has the largest assignment quantity, among the plurality of pieces of assignment pattern information recorded by the assignment pattern recording unit; and
an assignment time period determining unit that determines an assignment time period according to the assignment pattern indicated by the selected assignment pattern information to be a time period before the earliest assignment due date of all types of assignment objects.

3. The planning apparatus according to claim 1, wherein
the assignment object is a part for manufacturing a finished product,
the assignment plan is a production plan that combines a production pattern of the part and a production time according to the production pattern.

4. The planning apparatus according to claim 1, wherein the calculating unit, the determining unit, the assignment pattern determining unit, and the plan adding unit are configured to respectively repeat calculating, determining, deciding, and adding until the determining unit determines that there is no time period in which the allowance quantity is lower than the preset lower limit.

5. A planning method comprising causing a planning apparatus to perform a calculating step, a determining step, an assignment pattern determining step, and a plan adding step, the planning apparatus comprising:
a requested quantity recording unit that records a requested quantity for which an assignment of a plurality of types of assignment objects is requested, and a due date of the assignment;
a pattern recording unit that records a plurality of pieces of assignment pattern information indicating an assignment pattern that combines at least one type of assignment object assignable in parallel and an assignment quantity of every type of assignment object; and
a plan recording unit that records an assignment plan combining the assignment pattern with an assignment time period related to the assignment pattern;
wherein the planning apparatus performs:
the calculating step of calculating an allowance quantity of each assignment object for every time period by subtracting an accumulated value of requested quantities from an accumulated value of assignment quantities, based on the requested quantity of an assignment object requested to be assigned and the due date of an assignment, the requested quantity and the due date of an assignment being recorded by the requested quantity recording unit, and the assignment plan recorded by the plan recording unit,
the determining step of determining whether there is a time period in which the allowance quantity calculated by the calculating unit is lower than a preset lower limit,
the assignment pattern determining step of selecting at least one piece of assignment pattern information among the plurality of pieces of assignment pattern information recorded by the pattern recording unit if the determining unit has determined that there is a time period in which the allowance quantity is lower than the preset lower limit, and determining an assignment time period related to the assignment pattern indicated by the selected assignment pattern information, and
the plan adding step of adding the assignment pattern and the assignment time period determined in the assignment pattern determining step to the assignment plan recorded by the plan recording unit.

6. A computer program product having a computer program code stored in a tangible computer readable medium when executed by a processor, the computer program product comprising computer program code that cause a computer to execute:
a procedure of acquiring a requested quantity of an assignment object for every type requested to be assigned and a requested time period from a requested quantity recording unit having recorded therein requested quantities of a plurality of types of assignment objects which are requested to be assigned and a due dates of an assignment;
a procedure of acquiring assignment pattern information from a pattern recording unit in which a plurality of pieces of assignment pattern information indicating an assignment pattern are recorded, the assignment pattern combining at least one type of assignment object assignable in parallel and an assignment quantity of every type of assignment object;
a procedure of acquiring an assignment plan from a plan recording unit in which an assignment plan combining the assignment pattern with an assignment time period related to the assignment pattern is recorded;
a calculating procedure of calculating an allowance quantity of each assignment object for every time period by subtracting an accumulated value of requested quantities from an accumulated value of assignment quantities, based on the requested quantity of an assignment object requested to be assigned and the requested time, the requested quantity and the requested time being acquired from the requested quantity recording unit, and the assignment plan acquired from the plan recording unit;
a determining procedure of determining whether there is a time period in which the allowance quantity calculated by the calculating unit is lower than a preset lower limit,
an assignment pattern determining procedure of selecting at least one piece of assignment pattern information among the plurality of pieces of assignment pattern information acquired from the pattern recording unit if a time period in which the allowance quantity is lower than the preset lower limit exists, and determining an assignment time period according to the assignment pattern indicated by the selected at least one piece of assignment pattern information, and
a plan adding procedure of adding the assignment pattern and the assignment time period determined in the assignment pattern determining procedure to the assignment plan recorded by the plan recording unit.
